(19) United States
(12) Patent Application Publication
(10) Pub. No.: US 2026/0274673 A1
(43) Pub. Date: Sep. 17, 2026

(54) CARBON MATERIAL, METHOD FOR PRODUCING CARBON MATERIAL, CATALYST, DISPERSION LIQUID, ELECTRODE, BATTERY, AND ELECTROLYSIS DEVICE

(71) Applicants: DIC Corporation, Itabashi-ku, Tokyo (JP); The University of Osaka, Suita-shi, Osaka (JP)

(72) Inventors: Keisuke SAKAMOTO, Chiba (JP); Kengo YASUI, Ibaraki (JP); Yasuhiro SHIRAISHI, Osaka (JP); Takayuki HIRAI, Osaka (JP)

(21) Appl. No.: 19/166,801

(22) PCT Filed: Mar. 21, 2024
(86) PCT No.: PCT/JP2024/011156

§ 371 Date: Sep. 18, 2025

(30) Foreign Application Priority Data
Apr. 6, 2023 (JP) 2023-062259

(51) Int. Cl. C01B 32/05; C01B 32/00; C25B 11/043; H01M 4/90; H01M 12/06; H01M 12/08

(52) U.S. Cl. CPC C01B 32/05; C01B 32/00; C25B 11/043; H01M 4/90; H01M 12/06; H01M 12/08

(57) ABSTRACT

A carbon material containing a fired product of a mixture containing a first compound and a second compound, in which the first compound is a phthalocyanine compound having bromine as a substituent, and the second compound is a compound containing at least one metal element selected from the group consisting of Fe, Co, Ni, Cu, Al, and Zn.

### TECHNICAL FIELD

The present disclosure relates to a carbon material, a method for producing a carbon material, a catalyst, a dispersion liquid, an electrode, a battery, and an electrolysis device.

### BACKGROUND ART

Carbon materials are used in a wide range of applications because of their characteristics such as high electrical conductivity, high thermal conductivity, low thermal expansion coefficient, lightness, and heat resistance. In recent years, the use of a carbon material containing nitrogen as a catalyst for a positive electrode (oxygen reduction catalyst) of a fuel cell or an air cell has been studied (see Patent Document 1). The carbon material containing nitrogen may have carbon dioxide reduction activity or nitrogen reduction activity, and also has attracted attention as a catalyst for a cathode (carbon dioxide reduction catalyst or nitrogen reduction catalyst) in an electrolysis device (see Non-Patent Document 1 and Non-Patent Document 2).

### CITATION LIST

### Patent Literature

Patent Document 1: JP 2012-101155 A
Patent Document 2: WO 2021/220495

### Non-Patent Document

Non-Patent Document 1: Angew. Chem. Int. Ed., 2015, 54, 10758-10762
Non-Patent Document 2: Nature Communications, 2019, 10, 341-348

### SUMMARY OF INVENTION

### Technical Problem

An object of one aspect of the present disclosure is to provide a novel carbon material that can be used in an oxygen reduction catalyst. An object of another aspect of the present disclosure is to provide a carbon material having excellent oxygen reduction activity.

### Solution to Problem

Some aspects of the present disclosure provide the following [1] to [17].

[1]

A carbon material containing a fired product of a mixture containing a first compound and a second compound, wherein

the first compound is a phthalocyanine compound having bromine as a substituent, and

the second compound is a compound containing at least one metal element selected from the group consisting of Fe, Co, Ni, Cu, Al, and Zn.

[2]

The carbon material according to [1], wherein the phthalocyanine compound contains Fe, Co, or Zn as a central metal.

[3]

The carbon material according to [1], wherein the phthalocyanine compound contains Zn as a central metal.

[4]

The carbon material according to any one of [1] to [3], wherein the phthalocyanine compound has an average number of bromine atoms of 4 or more.

[5]

The carbon material according to any one of [1] to [4], wherein the phthalocyanine compound is in a powder form, and

a powder formed of the phthalocyanine compound has an average particle size of 300 nm or less.

[6]

The carbon material according to any one of [1] to [5], wherein the second compound is a phthalocyanine compound or porphyrin compound having no bromine as a substituent.

[7]

The carbon material according to any one of [1] to [6], wherein the second compound is a compound containing Fe.

[8]

The carbon material according to any one of [1] to [7], wherein a mass ratio of a content of the first compound to a content of the second compound in the mixture is from 0.1 to 2000.

[9]

A method for producing the carbon material described in any one of [1] to [8], the method including:
firing a raw material containing the first compound and the second compound.

A catalyst for use in a reduction reaction of oxygen, containing the carbon material described in any one of [1] to [8].

A dispersion liquid containing the carbon material described in any one of [1] to [8] and a dispersion medium for the carbon material.

The dispersion liquid according to [11], containing a polymer electrolyte.

The dispersion liquid according to or [12], the dispersion liquid being used for forming an electrode catalyst layer.

An electrode containing an electrode catalyst layer containing the carbon material described in any one of [1] to [8].

The electrode according to [14], wherein the electrode catalyst layer contains a polymer electrolyte.

A battery including the electrode described in or [15].

An electrolysis device including the electrode described in or [15].

### Advantageous Effects of Invention

According to one aspect of the present disclosure, a novel carbon material that can be used in an oxygen reduction catalyst can be provided.

### DESCRIPTION OF EMBODIMENTS

In the present specification, numerical ranges indicated using “to” indicate ranges that include numerical values described before and after “to” as a minimum value and a maximum value, respectively. In addition, unless otherwise specifically indicated, the units of the numerical values described before and after “to” are the same. In numerical ranges described stepwise in the present specification, an upper or lower limit of a numerical range at a stage may be replaced by an upper or lower limit of a numerical range at another stage. In a numerical range described herein, the upper or lower limit value of the numerical range may be replaced by a value presented in the examples (experimental examples). The upper limit values and the lower limit values described individually can be combined arbitrarily.

Hereinafter, preferred embodiments of the present disclosure will be described. However, the present disclosure is not limited to the following embodiments.

### Carbon Material

An embodiment of the present disclosure is a carbon material containing a fired product of a mixture containing a first compound and a second compound, wherein the first compound is a phthalocyanine compound having bromine (Br) as a substituent (hereinafter also referred to as “brominated phthalocyanine compound”), and the second compound is a compound containing at least one metal element selected from the group consisting of Fe, Co, Ni, Cu, Al, and Zn.

The second compound is a compound different from the first compound, and is, for example, a compound not containing bromine (Br).

The carbon material contains the fired product of the mixture, and therefore exhibits excellent oxygen reduction activity. Therefore, the carbon material can be used in a catalyst for a reduction reaction of oxygen (oxygen reduction catalyst), and is used in a catalyst for a positive electrode of a fuel cell, an air cell, or the like, for example. The carbon material may also be used in a catalyst for a cathode of an oxygen electrolysis device in some cases. The carbon material tends to exhibit carbon dioxide reduction activity and nitrogen reduction activity, and therefore can also be used in a catalyst for a reduction reaction of carbon dioxide (carbon dioxide reduction catalyst) and a catalyst for a reduction reaction of nitrogen (nitrogen reduction catalyst). Specific applications include, for example, a catalyst for a cathode of a carbon dioxide electrolysis device and a nitrogen electrolysis device. The fact that the carbon material has oxygen reduction activity, carbon dioxide reduction activity, and nitrogen reduction activity can be confirmed by a method described in the examples (experimental examples).

The brominated phthalocyanine compound as the first compound has, for example, a structure represented by the following formula (1) or (2).

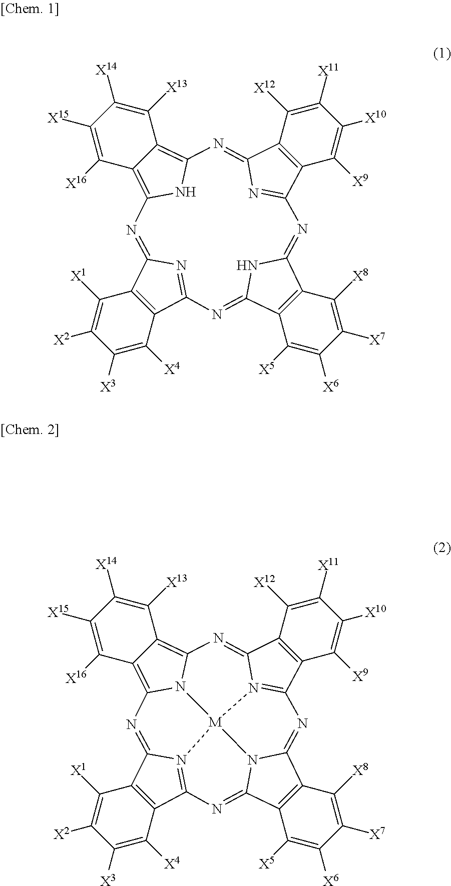

X¹ to X¹⁶ in the formula (1) and the formula (2) each independently represent a hydrogen atom or a halogen atom. However, at least one of X¹ to X¹⁶ is a bromine atom.

M in the formula (2) represents a central metal. Examples of the central metal (M) include Fe, Co, Ni, Cu, and Zn. The phthalocyanine compound having a central metal is sometimes referred to as “iron phthalocyanine” (central metal: Fe), “cobalt phthalocyanine” (central metal: Co), “copper phthalocyanine” (central metal: Cu), “zinc phthalocyanine” (central metal: Zn), or the like using a prefix corresponding to the type of the central metal.

The brominated phthalocyanine compound may not have the central metal (M), but in a case where the brominated phthalocyanine compound has the central metal (M), more excellent oxygen reduction activity, carbon dioxide reduction activity, and nitrogen reduction activity are likely to be obtained. From the viewpoint of easily obtaining further excellent oxygen reduction activity, the brominated phthalocyanine compound may contain Fe, Co, or Zn as the central metal (M), and from the viewpoint of easily obtaining further excellent oxygen reduction activity, the brominated phthalocyanine compound may contain Zn.

The halogen atom may be only a bromine atom, or may be a combination of a bromine atom and a halogen atom other than the bromine atom (a fluorine atom, a chlorine atom, and an iodine atom). The halogen atom may include a bromine atom and a chlorine atom.

Among the brominated phthalocyanine compounds, a phthalocyanine compound having bromine and chlorine as substituents and having Zn as a central metal (brominated chlorinated zinc phthalocyanine) is likely to provide further excellent oxygen reduction activity.

The brominated phthalocyanine compound contained in the mixture may be one type or two or more types.

An average number of bromine atoms of the brominated phthalocyanine compound, that is, an average for the number of bromine atoms in the brominated phthalocyanine compound (the number of bromine atoms per molecule) is more than 0, and, from the viewpoint of easily obtaining more excellent oxygen reduction activity, carbon dioxide reduction activity, and nitrogen reduction activity, may be 4 or more (for example, from 4 to 16), may be 5 or more, 8 or more, or 11 or more, and may be 15 or less or 13 or less.

An average number of chlorine atoms of the brominated phthalocyanine compound, that is, an average for the number of chlorine atoms in the brominated phthalocyanine compound (the number of chlorine atoms per molecule) may be more than 0 and 11 or less, may be 0.1 or more, 0.5 or more, or 1 or more, and may be 3 or less or 2 or less, from the viewpoint of easily obtaining more excellent oxygen reduction activity, carbon dioxide reduction activity, and nitrogen reduction activity.

An average number of halogen atoms of the brominated phthalocyanine compound, that is, an average for the total number of halogen atoms in the brominated phthalocyanine compound (the total number of halogen atoms per molecule) is more than 0, and, from the viewpoint of easily obtaining more excellent oxygen reduction activity, carbon dioxide reduction activity, and nitrogen reduction activity, may be from 8 to 16, may be 11 or more, and may be 15 or less or 14 or less.

The number of halogen atoms can be specified by, for example, mass spectrometry using a matrix-assisted laser desorption-ionization time-of-flight mass spectrometer (such as JMS-S3000 available from JEOL Ltd.). Specifically, the number of each halogen atom can be calculated as a relative value per central metal element from a mass ratio between the central metal element and each halogen atom in the brominated phthalocyanine compound.

The brominated phthalocyanine compound is, for example, in a powder form. As a powder formed of the brominated phthalocyanine compound is finer, the fired product becomes finer, and more excellent oxygen reduction activity, carbon dioxide reduction activity, and nitrogen reduction activity are easily obtained. From such a viewpoint, an average particle size (average value of major axes of primary particles) of the powder formed of the brominated phthalocyanine compound may be 300 nm or less (for example, from 10 to 300 nm), 200 nm or less (for example, from 10 to 200 nm), 100 nm or less (for example, from 10 to 100 nm), 70 nm or less (for example, from 10 to 70 nm), 60 nm or less (for example, from 10 to 60 nm), or 40 nm or less (for example, from 10 to 40 nm), and may be 40 nm or more (for example, from 40 to 200 nm) or 70 nm or more (for example, from 70 to 200 nm). An average aspect ratio of the powder formed of the brominated phthalocyanine compound may be, for example, from 1.0 to 3.0. The powder having such an average particle size and such an average aspect ratio can be produced by, for example, a method described in WO 2021/220495 or the like.

The second compound contains at least one metal element selected from the group consisting of Fe, Co, Ni, Cu, Al, and Zn. In a case where the second compound contains Fe, more excellent oxygen reduction activity, carbon dioxide reduction activity, and nitrogen reduction activity are easily obtained. When the first compound has a metal element (that is, when the brominated phthalocyanine compound has a central metal), the second compound may contain a metal element different from the metal element contained in the first compound.

In the second compound, the metal element may be a metal element contained as a central metal of a phthalocyanine compound or a porphyrin compound. That is, the second compound may be a phthalocyanine compound having no bromine as a substituent, or may be a porphyrin compound having no bromine as a substituent. In a case where the second compound is a phthalocyanine compound or porphyrin compound having no bromine as a substituent, more excellent oxygen reduction activity, carbon dioxide reduction activity, and nitrogen reduction activity are easily obtained. The phthalocyanine compound and the porphyrin compound may have a halogen element (fluorine, chlorine, or iodine) other than bromine as a substituent.

The second compound may be a metal salt containing the metal element. Examples of the metal salt include sulfates, nitrates, carbonates, phosphates, chromates, metal porphyrin complexes, metal phthalocyanine complexes, alkaline metal salts, alkaline earth metal salts, earth metal salts, transition metal salts, ammonium salts, hydrogen acid salts, and oxo acid salts.

Specific examples of the second compound include metal phthalocyanines such as iron phthalocyanine, cobalt phthalocyanine, nickel phthalocyanine, copper phthalocyanine, and aluminum chloride phthalocyanine, and chlorinated products obtained by substituting some of hydrogen atoms of these with chlorine atoms (M in the formula (2) is Fe, Co, Ni, Cu, Al, or Zn, and any one of X¹ to X¹⁶ is a chlorine atom); iron tetraphenylporphyrin chloride, tris(dibenzoylmethanato) iron, iron sulfate (for example, iron (II) sulfate heptahydrate), and iron chloride (for example, iron (III) chloride hexahydrate, iron (II) chloride tetrahydrate).

The second compound is, for example, in a powder form. As a powder formed of the second compound is finer, the fired product becomes finer, and more excellent oxygen reduction activity, carbon dioxide reduction activity, and nitrogen reduction activity are easily obtained. From such a viewpoint, an average particle size (average value of major axes of primary particles) of the powder formed of the second compound may be 5000 nm or less (for example, from 10 to 5000 nm), may be 500 nm or less or 200 nm or less, and may be 30 nm or more or 50 nm or more.

The second compound contained in the mixture may be one type or two or more types.

A mixing ratio between the first compound and the second compound, that is, a mass ratio of a content C₁ of the first compound to a content C₂ of the second compound in the mixture (C₁/C₂), may be from 0.1 to 2000, may be 0.2 or more, 0.2 or more, 0.5 or more, 1 or more, 2 or more, or 10 or more, and may be 1000 or less, 500 or less, 100 or less, 50 or less, 10 or less, 2 or less, 1 or less, or 0.5 or less, from the viewpoint of easily obtaining more excellent oxygen reduction activity, carbon dioxide reduction activity, and nitrogen reduction activity.

The mixture may be formed of the first compound and the second compound alone, or may further contain a component (additional component) other than the first compound and the second compound. A total content of the first compound and the second compound in the mixture may be 50 mass % or more, or may be 80 mass % or more, or 90 mass % or more based on a total mass of the mixture from the viewpoint of easily obtaining a carbon material having more excellent oxygen reduction activity, carbon dioxide reduction activity, and nitrogen reduction activity. The total content of the first compound and the second compound in the mixture may be 100 mass %, or may be 99 mass % or less, or 95 mass % or less, based on the total mass of the mixture.

Examples of the additional component include organic compounds containing no metal element. Examples of such organic compounds include phenol resin, polyfurfuryl alcohol, furan, furan resin, phenol-formaldehyde resin, epoxy resin, polyvinylidene chloride, polythiophene, polysulfone, polyvinyl alcohol, polyvinyl butyral, polyester, polylactic acid, polyether, polyether ether ketone, cellulose, carboxymethyl cellulose, lignin, pitch, polycarbazole, polyacrylic acid, polyacrylic ester, polymethacrylic ester, and polymethacrylic acid.

As the additional component, a carbon material such as graphite, activated carbon, amorphous carbon, carbon black, coal, charcoal, coke, carbon nanotube, fullerene, or graphene can also be used.

The carbon material may be formed of the fired product, or may contain a component other than the fired product. A content of the fired product in the carbon material may be 50 mass % or more, or may be 80 mass % or more, or 90 mass % or more based on a total mass of the carbon material from the viewpoint of easily obtaining more excellent oxygen reduction activity. The content of the fired product in the carbon material may be 100 mass %, or may be 99 mass % or less, or 95 mass % or less, based on the total mass of the carbon material.

The carbon material may have a form corresponding to the form of the fired product. The form of the carbon material is not particularly limited, and may be, for example, a powder form. A median diameter of the carbon material may be, for example, from 0.01 to 50 μm, or may be from 0.01 to 10 μm. The median diameter of the carbon material is a D50 particle diameter measured by a laser diffraction-type particle size distribution measuring device equipped with an air flow-type dry disperser.

An average particle size of the carbon material may be, for example, from 0.01 to 1 μm, may be 0.35 μm or less or 0.1 μm or less, and may be 0.05 m or more. In particular, when the average particle size of the carbon material is from 0.01 to 0.35 μm, more excellent oxygen reduction activity tends to be easily obtained. The average particle size is the average particle size of primary particles (average primary particle size), and can be calculated from an average value of 40 primary particles constituting an aggregate on a two dimensional image obtained by ultrasonically dispersing a sample in cyclohexane and then photographing the sample with a microscope.

The carbon material may have pores of a size corresponding to an element (nitrogen (N), bromine (Br), chlorine (Cl), metal element (M), or the like) other than carbon contained in the first compound and the second compound. That is, the carbon material may be a porous carbon material (for example, a porous carbon material in a powder form).

A specific surface area (BET specific surface area) of the carbon material may be, for example, 100 m²/g or more, or may be 200 m²/g or more, or 300 m²/g or more. The specific surface area (BET specific surface area) of the carbon material may be 2000 m²/g or less, or may be 1500 m²/g or less, or 1000 m²/g or less. From these viewpoints, the specific surface area (BET specific surface area) of the carbon material may be, for example, from 100 to 2000 m²/g.

The carbon material described above is a material mainly containing carbon (C), but may contain an element (nitrogen (N), bromine (Br), chlorine (Cl), metal element (M), or the like) other than carbon contained in the first compound and the second compound.

A content of carbon (C) in the carbon material may be, for example, 60 mass % or more, or may be 70 mass % or more or 80 mass % or more. The content of carbon (C) in the carbon material is a content based on the total mass of the carbon material, and can be measured by CHN elemental analysis using a combustion method.

A content of nitrogen (N) in the carbon material may be, for example, an amount such that the number of nitrogen atoms relative to the number of carbon atoms in the carbon material, which is 1, is 0.300 or less, or may be an amount such that the number of nitrogen atoms is 0.220 or less, or 0.140 or less. The content of nitrogen (N) in the carbon material may be 0 ppm by mass, but may be an amount such that the number of nitrogen atoms relative to the number of carbon atoms in the carbon material, which is 1, is 0.005 or more, 0.010 or more, or 0.050 or more. The number of carbon atoms and the number of nitrogen atoms in the carbon material can be measured by X-ray photoelectron spectroscopy (XPS).

A content of bromine (Br) in the carbon material may be, for example, 100000 ppm by mass or less, or may be 50000 ppm by mass or less, or 20000 ppm by mass or less. The content of bromine (Br) in the carbon material may be 0 ppm by mass, but may be 50 ppm by mass or more, 500 ppm by mass or more, or 2000 ppm by mass or more. The content of bromine in the carbon material is, the content of bromine in the carbon material is a content based on the total mass of the carbon material, and can be measured by a combustion ion chromatograph (CIC) method.

A content of chlorine (Cl) in the carbon material may be, for example, 30000 ppm by mass or less, or may be 10000 ppm by mass or less, 5000 ppm by mass or less, 1000 ppm by mass or less, 500 ppm by mass or less, or 100 ppm by mass or less. The content of chlorine (Cl) in the carbon material may be 0 ppm by mass, but may be 10 ppm by mass or more. The content of chlorine (Cl) in the carbon material is a content based on the total mass of the carbon material, and can be measured by the combustion ion chromatograph (CIC) method.

A content of the metal element (M) in the carbon material may be, for example, 20 mass % or less, or may be 5 mass % or less or 2 mass % or less.

The content of the metal element (M) in the carbon material may be 0 ppm by mass, but may be 0.005 mass % or more, 0.1 mass % or more, or 1 mass % or more. The content of the metal element is a content based on the total mass of the carbon material, and can be measured by inductively coupled plasma-optical emission spectrometry (ICP-OES).

### Method for Producing Carbon Material

Another embodiment of the present disclosure is a method for producing a carbon material, the method including a step of firing a raw material containing a first compound and a second compound, wherein the first compound is a phthalocyanine compound having bromine as a substituent, and the second compound is a compound containing at least one metal element selected from the group consisting of Fe, Co, Ni, Cu, Al, and Zn.

According to the method, the carbon material of the above embodiment is obtained. That is, according to the method, a novel carbon material that can be used in an oxygen reduction catalyst is obtained.

As the raw material, the above-described mixture can be used. That is, as the first compound and the second compound, the first compound and the second compound described above can be used, and examples thereof are the same as the examples described above. Examples of a total amount of the first compound and second compound to be used (based on the total mass of the raw material) are the same as the examples of the total content of the first compound and the second compound (based on the total mass of the mixture) described above. Examples of a ratio (mass ratio) between the amounts of the first compound and second compound to be used are the same as the examples of the mixing ratio (mass ratio) between the first compound and the second compound described above. Examples of an additional component that can be used in the raw material are the same as the examples of the additional component that can be contained in the mixture.

A firing temperature of the raw material may be any temperature at which the raw material can be carbonized, and may be, for example, 600° C. or higher. The firing temperature of the raw material may be 700° C. or higher, or may be 800° C. or higher, or 900° C. or higher, from the viewpoint of easily obtaining a carbon material having more excellent oxygen reduction activity, carbon dioxide reduction activity, and nitrogen reduction activity. The firing temperature of the raw material may be, for example, 1500° C. or lower, or may be 1200° C. or lower, or 1000° C. or lower from the viewpoint of suppressing high crystallization of the carbon material. From these viewpoints, the firing temperature of the raw material may be, for example, from 600 to 1500° C., or may be from 700 to 1500° C.

A firing time of the raw material may be, for example, from 0.5 to 6 hours.

An atmosphere gas during firing may be an inert gas, an oxidizing gas, a reducing gas, or a mixed gas thereof. Examples of the inert gas include argon, helium, and nitrogen. Examples of the oxidizing gas include carbon dioxide. Examples of the reducing gas include hydrogen and ammonia. From the viewpoint of porosity of the resulting carbon material, the atmosphere gas may contain at least one selected from the group consisting of nitrogen, ammonia, and carbon dioxide. For example, an ammonia-containing gas may be used if the specific surface area is to be improved. Mixing helium with ammonia tends to be capable of improving a total volume of either mesopores or micropores. A concentration of ammonia in the ammonia-containing gas may be, for example, from 0.1 to 50 vol %.

The raw material may be fired by a one-stage heat treatment or a two or more-stage heat treatment. For example, the heat treatment may be performed at a temperature of 600° C. or higher after the heat treatment at a temperature of lower than 600° C.

When the two or more-stage heat treatment is performed, the second stage may be performed in an atmosphere different from that of the first stage. By setting the gas atmosphere at the second stage different from that at the first stage, the specific surface area, the total volumes of mesopores and micropores, and the like can be easily controlled.

In an embodiment of the present disclosure, the obtained fired product may be cleaned. That is, the fired product constituting the carbon material may be a fired product after cleaning. The cleaning method is not particularly limited, and examples thereof include water washing, acid cleaning, and alkali cleaning. The cleaning method may be acid cleaning from the viewpoint of controlling the content of the metal element. Examples of the acid include hydrochloric acid and sulfuric acid.

### (Catalyst)

Another embodiment of the present disclosure is a catalyst (for example, an electrode catalyst) including the carbon material of the above embodiment. The catalyst of an embodiment may be an oxygen reduction catalyst, a carbon dioxide reduction catalyst, or a nitrogen reduction catalyst. The oxygen reduction catalyst may be a two-electron reduction catalyst that catalyzes a two-electron reduction reaction of oxygen or may be a four-electron reduction catalyst that catalyzes a four-electron reduction reaction of oxygen, but tends to exhibit more excellent catalytic activity when used as a four-electron reduction catalyst. Since the carbon material of the above embodiment exhibits catalytic ability as an oxygen reduction catalyst under both acidic conditions and basic conditions, the oxygen reduction catalyst of the present embodiment can be used under both acidic conditions and basic conditions.

### (Dispersion Liquid)

Another embodiment of the present disclosure is a dispersion liquid containing the carbon material of the above embodiment and a dispersion medium for the carbon material. The dispersion liquid is used for forming an electrode catalyst layer. That is, one aspect of the dispersion liquid is an ink composition for forming an electrode catalyst layer.

As described above, the carbon material of the above embodiment can function as an oxygen reduction catalyst, a carbon dioxide reduction catalyst, or a nitrogen reduction catalyst, and thus the dispersion liquid is useful for forming an electrode catalyst layer for an oxygen reduction electrode (for example, a positive electrode catalyst layer of a fuel cell, an air cell, or the like, and a cathode catalyst layer of an oxygen electrolysis device), an electrode catalyst layer for a carbon dioxide reduction electrode (for example, a cathode catalyst layer of a carbon dioxide electrolysis device), or an electrode catalyst layer for a nitrogen reduction electrode (for example, a cathode catalyst layer of a nitrogen electrolysis device).

As the dispersion medium, a known dispersion medium used for forming an electrode catalyst layer of the cell or the electrolysis device can be used. For example, water, lower alcohols (methanol, ethanol, isopropyl alcohol, normal propyl alcohol, etc.), and mixtures thereof can be used. A content of the dispersion medium may be appropriately adjusted so that a viscosity of the dispersion liquid is suitable for an application device. The content of the dispersion medium in the dispersion liquid may be, for example, from 60 to 99.5 mass % based on a total mass of the dispersion liquid.

The dispersion liquid may be composed only of the carbon material and the dispersion medium, but may contain, in addition to these, a known material used for forming an electrode catalyst layer of the cell or the electrolysis device. The dispersion liquid may further contain, for example, a binder for the carbon material. As the binder, a known organic polymer compound can be used, and a polymer electrolyte may be used from the viewpoint of being capable of forming an ion conductive path. Examples of the polymer electrolyte include perfluorosulfonic acid polymers such as Nafion (registered trademark).

When the dispersion liquid contains solids (for example, the binder) other than the carbon material, the content of the carbon material may be from 40 to 80 mass % based on a total amount of the solids in the dispersion liquid. A content of the binder in the dispersion liquid may be from 20 to 60 mass % based on the total amount of the solids in the dispersion liquid. When the dispersion liquid contains a polymer electrolyte, a content of the polymer electrolyte may be from 20 to 60 mass % based on the total amount of the solids in the dispersion liquid. The total amount of the solids refers to a total amount of components other than the dispersion medium contained in the dispersion liquid.

The dispersion liquid may further contain a carbon material other than the carbon material of the above embodiment, but a content of the carbon material other than the carbon material of the above embodiment may be 40 mass % or less based on a total amount of all the carbon materials.

### (Electrode)

Another embodiment of the present disclosure is an electrode including an electrode catalyst layer containing the carbon material of the above embodiment. The electrode may be an oxygen reduction electrode (for example, a positive electrode of a fuel cell or an air cell, or a cathode of an oxygen electrolysis device), may be a carbon dioxide reduction electrode (for example, a cathode of a carbon dioxide electrolysis device), or may be a nitrogen reduction electrode (for example, a cathode of a nitrogen electrolysis device). As the configuration of the electrode other than the electrode catalyst layer, a typically known configuration for an oxygen reduction electrode, a carbon dioxide reduction electrode, a nitrogen reduction electrode, or the like can be adopted. The electrode of an embodiment may further include, for example, a gas diffusion layer, a microporous layer, and the like.

The electrode catalyst layer may be composed only of the carbon material, but may contain a component other than the carbon material depending on the application. Examples of the component other than the carbon material include a binder such as the above-described polymer electrolyte. Ranges of the contents of the carbon material, the binder, and the polymer electrolyte in the electrode catalyst layer (based on a total mass of the electrode catalyst layer) may be the same as the ranges of the contents of the carbon material, the binder, and the polymer electrolyte in the dispersion liquid of the above-described embodiment (based on the total amount of the solids in the dispersion liquid).

The electrode catalyst layer can be formed using the dispersion liquid of the above embodiment. For example, the electrode catalyst layer may be obtained by applying the dispersion liquid onto a support and drying the dispersion liquid. The application method is not particularly limited, and a general method using, for example, a bar coater, a spray coater, or a screen printer can be used.

The electrode may be a part of a membrane electrode assembly (MEA) constituting a fuel cell. The MEA includes, for example, a positive electrode catalyst layer, a negative electrode catalyst layer, an electrolyte membrane disposed between the positive electrode catalyst layer and the negative electrode catalyst layer, and a pair of gas diffusion layers disposed on sides of the positive electrode catalyst layer and the negative electrode catalyst layer opposite to the electrolyte membrane side.

### (Battery)

Another embodiment of the present disclosure is a battery including the electrode of the above embodiment. This battery is, for example, a battery including the electrode of the above embodiment as an oxygen reduction electrode (positive electrode), and may be a fuel cell or an air cell. Examples of the fuel cell include a polymer electrolyte fuel cell (PEFC), a phosphoric acid fuel cell (PAFC), an alkaline fuel cell (AFC), a molten carbonate fuel cell (MCFC), a solid oxide fuel cell (SOFC), and a microbial fuel cell (MFC). As the configuration of the battery other than the positive electrode, a typically known configuration for a fuel cell, an air cell, or the like can be adopted. The battery of an embodiment may be, for example, a fuel cell including a membrane electrode assembly (MEA) including the electrode.

### (Electrolysis Device)

Another embodiment of the present disclosure is an electrolysis device including the electrode of the above embodiment. The electrolysis device may be an electrolysis device (oxygen electrolysis device) including the electrode of the above embodiment as an oxygen reduction electrode (cathode), may be an electrolysis device (carbon dioxide electrolysis device) including the electrode of the above embodiment as a carbon dioxide reduction electrode (cathode), or may be an electrolysis device (nitrogen electrolysis device) including the electrode of the above embodiment as a nitrogen reduction electrode (cathode). The oxygen electrolysis device can also be referred to as a hydrogen peroxide synthesis device because it synthesizes hydrogen peroxide with decomposition of oxygen. As the configuration of the battery other than the cathode, a typically known configuration for an oxygen electrolysis device, a carbon dioxide electrolysis device, a nitrogen electrolysis device, or the like can be adopted.

### EXAMPLES

Hereinafter, the contents of the present disclosure will be described in more detail using experimental examples, but the present disclosure is not limited to the following experimental examples.

### Method for Measuring Number of Halogen Atoms

The number of halogen atoms (average number of bromine atoms and average number of chlorine atoms) of each of materials used in the experimental examples was determined by mass spectrometry using JMS-S3000 available from JEOL Ltd.

### Method for Measuring Average Particle Size

The average particle size of each of the materials used in the experimental examples (average primary particle size) was calculated from an average value of 40 primary particles constituting an aggregate on a two dimensional image obtained by ultrasonically dispersing the material in cyclohexane and then photographing the material with a microscope.

### Experimental Example 1

As a raw material 1, a raw material powder A formed of C.I. Pigment Green 58 (zinc phthalocyanine having bromine and chlorine as substituents, average number of bromine atoms: from 11 to 16, average number of chlorine atoms: from 0 to 5, average particle size: from 10 to 60 nm, “BrCI-ZnPc (A)” in Table 1) available from DIC Corporation was prepared. As a raw material 2, iron phthalocyanine (“FePc” in Table 1, available from Tokyo Chemical Industry Co., Ltd., iron (II) phthalocyanine, product code: P0774, average particle size: 110 nm, the same applies hereinafter) was prepared. Next, the raw material powder A (raw material 1) and the iron phthalocyanine (raw material 2) were mixed at a mass ratio of 10:1 (raw material 1: raw material 2) to prepare a raw material mixture.

On a boat for firing (SSA-S 5B, CC brand, available from Nikkato Corporation; alumina: 99.6%), 1.0 g of the raw material mixture was placed, and the boat was placed in the center of a quartz reaction tube. After purging the air remaining in the tube by passing nitrogen gas through the tube for 20 min at 500 ml/min, the temperature was raised to 600° C. (firing temperature) at 10° C./min under a nitrogen flow (500 ml/min) in a tubular furnace, and retained for 2 hours. Thereafter, the mixture was cooled to room temperature under a nitrogen flow, and then a carbon material which was a fired product of the raw material mixture was taken out.

### Experimental Examples 2 and 3

Carbon materials were produced in the same manner as in Experimental Example 1, except that the firing temperature was changed from 600° C. to 900° C. or 1000° C.

### Experimental Examples 4 to 11

Carbon materials were produced in the same manner as in Experimental Example 2, except that the mixing ratio (mass ratio) between the raw material powder A (raw material 1) and the iron phthalocyanine (raw material 2) was changed to the ratios (raw material 1: raw material 2) shown in Table 1.

### Experimental Example 12

A carbon material was produced in the same manner as in Experimental Example 2, except that cobalt phthalocyanine (“CoPc” in Table 2, available from Tokyo Chemical Industry Co., Ltd., cobalt (II) phthalocyanine, product code: P0887, average particle size: 200 nm) was used, in place of the iron phthalocyanine, as the raw material 2.

### Experimental Example 13

A carbon material was produced in the same manner as in Experimental Example 2, except that copper phthalocyanine (“CuPc” in Table 2, available from Tokyo Chemical Industry Co., Ltd., copper (II) phthalocyanine ((type), product code: P1006, average particle size: 70 nm) was used, in place of the iron phthalocyanine, as the raw material 2.

### Experimental Example 14

A carbon material was produced in the same manner as in Experimental Example 2, except that nickel phthalocyanine (“NiPc” in Table 2, available from Sigma-Aldrich Co. LLC, nickel (II) phthalocyanine, product number: 360635, average particle size: 90 nm) was used, in place of the iron phthalocyanine, as the raw material 2.

### Experimental Example 15

A carbon material was produced in the same manner as in Experimental Example 2, except that aluminum chloride phthalocyanine (“AI (Cl) Pc” in Table 2, available from Tokyo Chemical Industry Co., Ltd., chloroaluminum phthalocyanine, product code: C1167, average particle size: 240 nm) was used, in place of the iron phthalocyanine, as the raw material 2.

### Experimental Example 16

A carbon material was produced in the same manner as in Experimental Example 2, except that iron tetraphenylporphyrin chloride (“FeTPP” in Table 2, available from Tokyo Chemical Industry Co., Ltd., iron (III) tetraphenylporphyrin chloride, product code: 10937, average particle size: 180 nm) was used, in place of the iron phthalocyanine, as the raw material 2.

### Experimental Example 17

A carbon material was produced in the same manner as in Experimental Example 2, except that a chlorinated iron phthalocyanine (“16Cl-FePc” in Table 2, available from Cosmo Bio Co., Ltd., product number: 097, average particle size: 130 nm) in which all of 16 hydrogen atoms were substituted with chlorine atoms was used, in place of the iron phthalocyanine, as the raw material 2.

### Experimental Example 18

A carbon material was produced in the same manner as in Experimental Example 2, except that iron (II) sulfate heptahydrate (“FeSO₄” in Table 2, available from FUJIFILM Wako Pure Chemical Corporation, average particle size: 430 nm) was used, in place of the iron phthalocyanine, as the raw material 2.

### Experimental Example 19

A carbon material was produced in the same manner as in Experimental Example 2, except that tris(dibenzoylmethanato) iron (“TDBM-Fe” in Table 2, available from Tokyo Chemical Industry Co., Ltd., tris(dibenzoylmethanato) iron, product code: T1686, average particle size: 260 nm) was used, in place of the iron phthalocyanine, as the raw material 2.

### Experimental Example 20

A raw material powder B formed of C.I. Pigment Green 59 (zinc phthalocyanine having bromine and chlorine as substituents, average number of bromine atoms: from 8 to 13, average number of chlorine atoms: from 0 to 5, average particle size: from 10 to 60 nm, “BrCI-ZnPc (B)” in Table 3) available from DIC Corporation was prepared. A carbon material was produced in the same manner as in Experimental Example 2 except that the raw material powder B was used, in place of the raw material powder A, as the raw material 1.

### Experimental Example 21

After 91 g of sulfuryl chloride (available from FUJIFILM Wako Pure Chemical Corporation), 109 g of aluminum chloride (available from Kanto Chemical Co., Inc.), 15 g of sodium chloride (available from Tokyo Chemical Industry Co., Ltd.), 30 g of copper phthalocyanine (available from Tokyo Chemical Industry Co., Ltd.), and 230 g of bromine (available from FUJIFILM Wako Pure Chemical Corporation) were charged into a 300-ml flask, the temperature was raised to 130° C. and retained at 130° C. for 4 hours. The reaction mixture (reaction solution) was taken out into water to precipitate a precipitate, and then the precipitate was filtered, washed with water, and dried to obtain a crude pigment powder. Into a double-arm kneader, 12 g of the crude pigment powder, 240 g of Nihon kaisui salt (available from Nihon kaisui Co., Ltd.), and 35 g of diethylene glycol were charged, and kneaded at 80° C. for 18 hours, and then the obtained mixture was taken out into 700 g of water. After stirring for 1 hour, the mixture was filtered, washed with hot water, dried, and ground to obtain a raw material powder C (copper phthalocyanine having bromine and chlorine as substituents, average number of bromine atoms: from 11 to 16, average number of chlorine atoms: from 0 to 5, average particle size: from 10 to 60 nm, “BrCI-CuPc” in Table 3).

A carbon material was produced in the same manner as in Experimental Example 2 except that the raw material powder C was used, in place of the raw material powder A, as the raw material 1.

### Experimental Example 22

A carbon material was produced in the same manner as in Experimental Example 21, except that cobalt phthalocyanine (“CoPc” in Table 3, available from Tokyo Chemical Industry Co., Ltd., cobalt (II) phthalocyanine, product code: P0887, the same applies hereinafter) was used, in place of the iron phthalocyanine, as the raw material 2.

### Experimental Example 23

After 91 g of sulfuryl chloride (available from FUJIFILM Wako Pure Chemical Corporation), 109 g of aluminum chloride (available from Kanto Chemical Co., Inc.), 15 g of sodium chloride (available from Tokyo Chemical Industry Co., Ltd.), 30 g of iron phthalocyanine, and 230 g of bromine (available from FUJIFILM Wako Pure Chemical Corporation) were charged into a 300-ml flask, the temperature was raised to 130° C. and retained at 130° C. for 4 hours. The reaction mixture (reaction solution) was taken out into water to precipitate a precipitate, and then the precipitate was filtered, washed with water, and dried to obtain a crude pigment powder. Into a double-arm kneader, 12 g of the crude pigment powder, 240 g of Nihon kaisui salt (available from Nihon kaisui Co., Ltd.), and 35 g of diethylene glycol were charged, and kneaded at 80° C. for 18 hours, and then the obtained mixture was taken out into 700 g of water. After stirring for 1 hour, the mixture was filtered, washed with hot water, dried, and ground to obtain a raw material powder D (iron phthalocyanine having bromine and chlorine as substituents, average number of bromine atoms: from 11 to 16, average number of chlorine atoms: from 0 to 5, average particle size: from 10 to 60 nm, “BrCI-FePc” in Table 3).

A carbon material was produced in the same manner as in Experimental Example 2 except that the raw material powder D was used, in place of the raw material powder A, as the raw material 1.

### Experimental Example 24

After 91 g of sulfuryl chloride (available from FUJIFILM Wako Pure Chemical Corporation), 109 g of aluminum chloride (available from Kanto Chemical Co., Inc.), 15 g of sodium chloride (available from Tokyo Chemical Industry Co., Ltd.), 30 g of cobalt phthalocyanine (available from Tokyo Chemical Industry Co., Ltd.), and 230 g of bromine (available from FUJIFILM Wako Pure Chemical Corporation) were charged into a 300-ml flask, the temperature was raised to 130° C. and retained at 130° C. for 4 hours. The reaction mixture (reaction solution) was taken out into water to precipitate a precipitate, and then the precipitate was filtered, washed with water, and dried to obtain a crude pigment powder. Into a double-arm kneader, 12 g of the crude pigment powder, 240 g of Nihon kaisui salt (available from Nihon kaisui Co., Ltd.), and 35 g of diethylene glycol were charged, and kneaded at 80° C. for 18 hours, and then the obtained mixture was taken out into 700 g of water. After stirring for 1 hour, the mixture was filtered, washed with hot water, dried, and ground to obtain a raw material powder E (cobalt phthalocyanine having bromine and chlorine as substituents, average number of bromine atoms: from 11 to 16, average number of chlorine atoms: from 0 to 5, average particle size: from 10 to 60 nm, “BrCI-CoPc” in Table 3).

A carbon material was produced in the same manner as in Experimental Example 2 except that the raw material powder E was used, in place of the raw material powder A, as the raw material 1.

### Experimental Example 25

In a 150-mL vial, 5 g of the raw material powder A and 100 g of propylene glycol monomethyl ether acetate were placed, and subjected to an ultrasonic treatment at 31 kHz for 8 hours using a tabletop ultrasonic cleaner W-113MKII available from HONDA ELECTRONICS CO., LTD. The mixture was filtered, washed with water, dried, and ground in a mortar to obtain a raw material powder F (zinc phthalocyanine having bromine and chlorine as substituents, average number of bromine atoms: from 11 to 16, average number of chlorine atoms: from 0 to 5, average particle size: 210 nm, “BrCI-ZnPc (F)” in Table 3).

A carbon material was produced in the same manner as in Experimental Example 2 except that the raw material powder F was used, in place of the raw material powder A, as the raw material 1.

### Experimental Example 26

In a 150-mL vial, 5 g of the raw material powder A and 100 g of cyclohexane were placed, and subjected to an ultrasonic treatment at 31 kHz for 8 hours using a tabletop ultrasonic cleaner W-113MKII available from HONDA

ELECTRONICS CO., LTD. The mixture was filtered, washed with water, dried, and ground in a mortar to obtain a raw material powder G (zinc phthalocyanine having bromine and chlorine as substituents, average number of bromine atoms: from 11 to 16, average number of chlorine atoms: from 0 to 5, average particle size: 70 nm, “BrCl-ZnPc (G)” in Table 3).

A carbon material was produced in the same manner as in Experimental Example 2 except that the raw material powder G was used, in place of the raw material powder A, as the raw material 1.

### Experimental Example 27

Into a double-arm kneader, 12 g of the raw material powder A, 240 g of Nihon kaisui salt (available from Nihon kaisui Co., Ltd.), and 35 g of diethylene glycol were charged, and kneaded at 80° C. for 18 hours. After kneading, the obtained mixture was taken out into 700 g of water. After stirring for 1 hour, the mixture was filtered, washed with hot water, dried, and ground to obtain a raw material powder H (zinc phthalocyanine having bromine and chlorine as substituents, average number of bromine atoms: from 11 to 16, average number of chlorine atoms: from 0 to 5, average particle size: 40 nm, “BrCI-ZnPc (H)” in Table 3).

A carbon material was produced in the same manner as in Experimental Example 2 except that the raw material powder H was used, in place of the raw material powder A, as the raw material 1.

### Experimental Example 28

A carbon material was produced in the same manner as in Experimental Example 2 except that zinc phthalocyanine (“ZnPc” in Table 3, available from DIC Corporation, the same applies hereinafter) was used in place of the raw material mixture.

### Experimental Example 29

A carbon material was produced in the same manner as in Experimental Example 2 except that iron phthalocyanine was used in place of the raw material mixture.

### Experimental Example 30

A carbon material was produced in the same manner as in Experimental Example 2 except that zinc phthalocyanine was used in place of the raw material powder A.

### Experimental Example 31

A carbon material was produced in the same manner as in Experimental Example 2 except that a mixed gas of ammonia and helium (ammonia concentration: 10 vol %) was used, in place of nitrogen, as the flowing gas.

### Experimental Example 32

In a 110-ml vial, 0.5 g of the carbon material obtained in Experimental Example 2 and 50 ml of 1 mol/L hydrochloric acid were placed, stirred at 70° C. for 1 hour, and then filtered and washed with water. Further, the same operation was repeated twice, and the obtained residue was dried overnight in an oven at 90° C. to produce a carbon material.

### Experimental Example 33

A carbon material was produced in the same manner as in Experimental Example 20, except that the raw material powder B (raw material 1) and iron phthalocyanine (raw material 2) were mixed at a mass ratio of 500:1 (raw material 1: raw material 2). In a 110-ml vial, 0.5 g of the obtained carbon material and 50 ml of 1 mol/L hydrochloric acid were placed, stirred at 70° C. for 1 hour, and then filtered and washed with water. Further, the same operation was repeated twice, and the obtained residue was dried overnight in an oven at 90° C. to produce a carbon material.

### Analysis

The BET specific surface areas of the carbon materials of Experimental Examples 1 to 33 were measured by a nitrogen adsorption method. The measurement was performed by a fully automatic specific surface area measuring device Macsorb HM model-1208 (available from Mountech Co., Ltd.) in accordance with “Method for Measuring Gas Adsorption Amount by One Point Method” specified in Appendix 2 of Japanese Industrial Standard JIS Z8830-1990. The results are shown in Tables 1 to 3.

### Evaluations

### (Evaluation of Oxygen Reduction Activity)

### Acidic Conditions

The oxygen reduction activity of the carbon materials of Experimental Examples 1 to 33 under acidic conditions was evaluated by the following method. As a reference example, the oxygen reduction activity of platinum-supporting carbon of platinum-supporting carbon (trade name: TEC10E10E, available from TANAKA PRECIOUS METAL TECHNOLOGIES Co., Ltd.), which has been typically used as a catalyst for an oxygen reduction electrode of a fuel cell, was also evaluated.

First, 4.1 mg of the carbon material or platinum-supporting carbon, 1680 μL of IPA (isopropyl alcohol), 420 μL of ultrapure water, and 30 μL of 5% Nafion (Sigma-Aldrich Co. LLC; product number: 510211) were weighed in a vial and mixed by irradiation with ultrasonic waves for 5 minutes to obtain a dispersion liquid. Four (4) μL of the dispersion liquid was added dropwise to a disk portion of a platinum ring GC disk electrode (RRDE) (BAS Inc., product number: 012613, ring portion outer diameter: 7.0 mm, ring portion inner diameter: 5.0 mm, disk portion outer diameter: 4.0 mm), and allowed to stand for about 10 minutes and dried. This operation was performed twice in total, and 8 μl in total of the dispersion liquid was applied to obtain a catalyst electrode for measurement (disk electrode area: 0.126 cm², amount of catalyst supported: 123 μg/cm²).

Next, the oxygen reduction activity of the catalyst electrode for measurement was evaluated by a three-electrode electrochemical cell method using an Ag/AgCl electrode (BAS Inc.; product number: 012167) as a reference electrode and a Pt coil electrode (BAS Inc.; product number: 012961) as a counter electrode. In particular, the measurement system was first stabilized by cycling in a range of from −0.1 to 0.7 V (vs. Ag/AgCl) at a scanning speed of 100 mV/s in a 0.1 M aqueous HClO₄ solution saturated with nitrogen (N₂). Next, a linear sweep voltammetric (LSV) measurement was performed in a 0.1 M aqueous HClO₄ solution saturated with oxygen (O₂) while rotating the catalyst electrode for measurement at 1600 rpm. The LSV measurement was performed by scanning in a range of from −0.1 to 0.7 V (vs. Ag/AgCl) from a noble potential to a base potential at 10 mV/s. The potential of the ring electrode was set to 0.9 V (vs. Ag/AgCl), which is a potential at which hydrogen peroxide can be sufficiently oxidized.

A voltammogram obtained by measurement with the Ag/AgCl electrode was converted to the RHE reference based on the following formula (a), and a disk current value I_{Disk}, a ring current value I_{Ring}, and a reaction onset potential Eₒₙₛₑₜ at 0.2 V (vs. RHE) were determined. In the following equation (a), E_{observed} is a potential based on the Ag/AgCl electrode, and E⁰_{Ag/Agcl} was 0.195 and the pH was 1.0.

$${E}_{RHE} = {E}_{A g / AgCl}^{0} + 0.059 pH + {E}_{observed} \qquad ( a )$$

In order to confirm a proportion of two-electron reduction reactions (reactions to generate hydrogen peroxide) in the catalyzed oxygen reduction reactions, a hydrogen peroxide generation rate (% H₂O₂) was determined based on the following equation (a1). A capture rate N was calculated based on the following equations (a2) to (a5) using a disk portion outer radius r₁ of the disk electrode, a ring portion inner radius r₂ of the ring electrode, and a ring portion inner radius r₃ of the ring electrode.

$$\% {H}_{2} {O}_{2} ( unit \% ) = 2 \times {l}_{Ring} / N / ( {l}_{D i s k} + {l}_{Ring} / N ) \qquad ( a1 )$$

$$N = 1 - F ( α / β ) + {β}^{2 / 3} [ 1 - F ( α ) ] - {( 1 + α + β )}^{2 / 3} \{ 1 - F [ ( α / β ) ( 1 + α + β ) ] \} \qquad ( a2 )$$

$$α = {( {r}_{2} / {r}_{1} )}^{3} - 1 \qquad ( a3 )$$

$$β = {( {r}_{3} / {r}_{1} )}^{3} - {( {r}_{2} / {r}_{1} )}^{3} \qquad ( a4 )$$

$$F ( θ ) = [ {3}^{1 / 2} / ( 4 π ) ] ln [ ( 1 + {θ}^{1 / 3} ) / ( 1 + θ ) ] + [ 3 / ( 2 π ) ] arctan [ ( 2 {θ}^{1 / 3} - 1 ) / {3}^{1 / 2} ] + 1 / 4 \qquad ( a5 )$$

In this evaluation, the potential at which 0.1 mA/cm² of a reduction current flows was defined as the reaction onset potential, and when the disk current value I_{Disk} at 0.2 V (vs. RHE) was −1.5 mA/cm² or less and the reaction onset potential was 0.5 V or more, the carbon material was determined to have oxygen reduction activity under acidic conditions, and when the disk current value I_{Disk} at 0.2 V (vs. RHE) was −4.0 mA/cm² or less and the reaction onset potential was 0.7 V or more, the carbon material was determined to have excellent oxygen reduction activity under acidic conditions. In addition, among the carbon materials determined to have oxygen reduction activity, those having a hydrogen peroxide generation rate (% H₂O₂) of 30% or more were determined to be particularly useful as a two-electron reduction reaction catalyst, and those having a hydrogen peroxide generation rate (% H₂O₂) of 15% or less were determined to be particularly useful as a four-electron reduction reaction catalyst. The results are shown in Tables 1 to 3.

### Basic Conditions

The oxygen reduction activity of the carbon materials of Experimental Examples 1 to 27 and 31 to 33 under basic conditions was evaluated in the same manner as in the measurement method under acidic conditions described above, except that a 0.1 M aqueous KOH solution was used in place of the 0.1 M aqueous HClO₄ solution, that the range of from −0.1 to 0.7 V (vs. Ag/AgCl) was changed to a range of from −0.7 to 0.1 V (vs. Ag/AgCl), and that the potential of the ring electrode was 0.2 V (vs. Ag/AgCl). However, the value substituted for pH in the above equation (a) for converting the voltammogram to the RHE reference was 13.

In this evaluation, the potential at which 0.1 mA/cm² of a reduction current flows was defined as the reaction onset potential, and when the disk current value I_{Disk} at 0.4 V (vs. RHE) was −2.8 mA/cm² or less and the reaction onset potential was 0.6 V or more, the carbon material was determined to have oxygen reduction activity under basic conditions, and when the disk current value I_{Disk} at 0.4 V (vs. RHE) was −4.0 mA/cm² or less and the reaction onset potential was 0.85 V or more, the carbon material was determined to have excellent oxygen reduction activity under basic conditions. In addition, among the carbon materials determined to have oxygen reduction activity, those having a hydrogen peroxide generation rate (% H₂O₂) of 30% or more were determined to be particularly useful as a two-electron reduction reaction catalyst, and those having a hydrogen peroxide generation rate (% H₂O₂) of 15% or less were determined to be particularly useful as a four-electron reduction reaction catalyst. The results are shown in Tables 1 to 3.

TABLE 1

| | Raw material | | | | | | Acidic conditions | | | Basic conditions | | |
|---|---|---|---|---|---|---|---|---|---|---|---|---|
| | | | Mass ratio | | | BET | I_{Disk} | % H₂O₂ | | I_{Disk} | % H₂O₂ | |
| | | | (raw | | | specific | V = | V = | Eₒₙₛₑₜ | V = | V = | Eₒₙₛₑₜ |
| | | | material | | | surface | 0.2 V | 0.2 V | A = −0.1 | 0.4 V | 0.4 V | A = −0.1 |
| | Raw | Raw | 1:raw | Firing | | area | (RHE) | (RHE) | mA/cm² | (RHE) | (RHE) | mA/cm² |
| | material 1 | material 2 | material 2) | temperature | Gas | [m²/g] | [mA/cm²] | [%] | [V] | [mA/cm²] | [%] | [V] |
| Experimental | BrCl—ZnPc | FePc | 10:1 | 600° C. | N₂ | 401 | −3.7 | 8.5 | 0.67 | −3.9 | 9.1 | 0.85 |
| Example 1 | (A) | | | | | | | | | | | |
| Experimental | BrCl—ZnPc | FePc | 10:1 | 900° C. | N₂ | 498 | −4.9 | 7.2 | 0.82 | −4.9 | 12.1 | 0.97 |
| Example 2 | (A) | | | | | | | | | | | |
| Experimental | BrCl—ZnPc | FePc | 10:1 | 1000° C. | N₂ | 589 | −5.0 | 7.5 | 0.80 | −4.8 | 7.1 | 0.97 |
| Example 3 | (A) | | | | | | | | | | | |
| Experimental | BrCl—ZnPc | FePc | 500:1 | 900° C. | N₂ | 348 | −4.9 | 8.6 | 0.79 | −4.1 | 28.4 | 0.78 |
| Example 4 | (A) | | | | | | | | | | | |
| Experimental | BrCl—ZnPc | FePc | 1000:1 | 900° C. | N₂ | 319 | −3.2 | 37.9 | 0.74 | −3.1 | 45.4 | 0.70 |
| Example 5 | (A) | | | | | | | | | | | |
| Experimental | BrCl—ZnPc | FePc | 2000:1 | 900° C. | N₂ | 314 | −2.6 | 52.6 | 0.70 | −3.4 | 45.6 | 0.70 |
| Example 6 | (A) | | | | | | | | | | | |
| Experimental | BrCl—ZnPc | FePc | 2:1 | 900° C. | N₂ | 522 | −5.2 | 12.1 | 0.82 | −3.8 | 18.4 | 0.96 |
| Example 7 | (A) | | | | | | | | | | | |
| Experimental | BrCl—ZnPc | FePc | 1:1 | 900° C. | N₂ | 383 | −3.8 | 16.1 | 0.78 | −3.7 | 40.1 | 0.92 |
| Example 8 | (A) | | | | | | | | | | | |
| Experimental | BrCl—ZnPc | FePc | 1:2 | 900° C. | N₂ | 286 | −3.2 | 15.0 | 0.78 | −3.7 | 34.2 | 0.92 |
| Example 9 | (A) | | | | | | | | | | | |
| Experimental | BrCl—ZnPc | FePc | 1:5 | 900° C. | N₂ | 259 | −2.6 | 17.6 | 0.77 | −3.0 | 48.3 | 0.91 |
| Example 10 | (A) | | | | | | | | | | | |
| Experimental | BrCl—ZnPc | FePc | 1:10 | 900° C. | N₂ | 249 | −2.5 | 20.3 | 0.74 | −3.4 | 35.5 | 0.91 |
| Example 11 | (A) | | | | | | | | | | | |

TABLE 2

| | Raw material | | | | | | | | | | | |
|---|---|---|---|---|---|---|---|---|---|---|---|---|
| | | | Mass | | | | Acid conditions | | | Basic conditions | | |
| | | | ratio | | | | I_{Disk} | % | | I_{Disk} | % | |
| | | | (raw | | | BET | V = | H₂O₂ | Eₒₙₛₑₜ | V = | H₂O₂ | Eₒₙₛₑₜ |
| | | | material | Fir- | | specific | 0.2 V | V = | A = −0.1 | 0.4 V | V = | A = −0.1 |
| | Raw | Raw | 1:raw | ing | | surface | (RHE) | 0.2 V | mA/ | (RHE) | 0.4 V | mA/ |
| | mate- | mate- | mate | temper- | | area | [mA/ | (RHE) | cm² | [mA/ | (RHE) | cm² |
| | rial 1 | rial 2 | rial 2) | ature | Gas | [m²/g] | cm²] | [%] | [V] | cm²] | [%] | [V] |
| Experimental | BrCl—ZnPc | CoPc | 10:1 | 900° C. | N₂ | 574 | −3.9 | 32.8 | 0.75 | −4.2 | 23.1 | 0.91 |
| Example 12 | (A) | | | | | | | | | | | |
| Experimental | BrCl—ZnPc | CuPc | 10:1 | 900° C. | N₂ | 647 | −6.2 | 3.1 | 0.74 | −5.2 | 10.3 | 0.82 |
| Example 13 | (A) | | | | | | | | | | | |
| Experimental | BrCl—ZnPc | NiPc | 10:1 | 900° C. | N₂ | 632 | −3.9 | 12.7 | 0.66 | −3.6 | 12.7 | 0.74 |
| Example 14 | (A) | | | | | | | | | | | |
| Experimental | BrCl—ZnPc | Al(Cl)Pc | 10:1 | 900° C. | N₂ | 541 | −3.9 | 14.9 | 0.74 | −4.1 | 36.3 | 0.90 |
| Example 15 | (A) | | | | | | | | | | | |
| Experimental | BrCl—ZnPc | FeTPP | 10:1 | 900° C. | N₂ | 549 | −3.9 | 12.9 | 0.83 | −4.3 | 30.7 | 0.94 |
| Example 16 | (A) | | | | | | | | | | | |
| Experimental | BrCl—ZnPc | 16Cl—FePc | 10:1 | 900° C. | N₂ | 391 | −4.9 | 9.1 | 0.81 | −5.5 | 11.7 | 0.97 |
| Example 17 | (A) | | | | | | | | | | | |
| Experimental | BrCl—ZnPc | FeSO4 | 10:1 | 900° C. | N₂ | 507 | −4.7 | 6.1 | 0.79 | −5.3 | 17.9 | 0.95 |
| Example 18 | (A) | | | | | | | | | | | |
| Experimental | BrCl—ZnPc | TDBM-Fe | 10:1 | 900° C. | N₂ | 675 | −4.9 | 6.6 | 0.80 | −5.4 | 14.2 | 0.97 |
| Example 19 | (A) | | | | | | | | | | | |

TABLE 3

| | Raw material | | | | | | | | | | | | |
|---|---|---|---|---|---|---|---|---|---|---|---|---|---|
| | | | Mass | | | | | Acidic conditions | | | Basic conditions | | |
| | | | ratio | | | | BET | | % | | | % | |
| | | | (raw | | | | spe- | I_{Disk} | H₂O₂ | | I_{Disk} | H₂O₂ | |
| | | | material | | | | cific | V = | V = | Eₒₙₛₑₜ | V = | V = | Eₒₙₛₑₜ |
| | Raw | Raw | 1:raw | Firing | | | surface | 0.2 V | 0.2 V | A = −0.1 | 0.4 V | 0.4 V | A = −0.1 |
| | mate- | mate- | material | temper- | | | area | (RHE) | (RHE) | mA/cm² | (RHE) | RHE | mA/cm² |
| | rial 1 | rial 2 | 2) | ature | Gas | Cleaning | (m²/g) | [mA/cm²] | [%] | [V] | [mA/cm²] | [%] | [V] |
| Experimental | BrCl—ZnPc | FePc | 10:1 | 900° C. | N₂ | No | 506 | −6.0 | 2.9 | 0.86 | −4.8 | 13.9 | 0.95 |
| Example 20 | (B) | | | | | | | | | | | | |
| Experimental | BrCl—CuPc | FePc | 10:1 | 900° C. | N₂ | No | 561 | −4.3 | 9.4 | 0.7 | −4.7 | 11.8 | 0.82 |
| Example 21 | | | | | | | | | | | | | |
| Experimental | BrCl—CuPc | CoPc | 10:1 | 900° C. | N₂ | No | 549 | −3.8 | 26.2 | 0.75 | −4.4 | 17.6 | 0.79 |
| Example 22 | | | | | | | | | | | | | |
| Experimental | BrCl—FePc | FePc | 10:1 | 900° C. | N₂ | No | 481 | −3.9 | 11.1 | 0.82 | −3.9 | 14.2 | 0.84 |
| Example 23 | | | | | | | | | | | | | |
| Experimental | BrCl—CoPc | FePc | 10:1 | 900° C. | N₂ | No | 597 | −4.0 | 20.2 | 0.78 | −5.4 | 13.3 | 1.03 |
| Example 24 | | | | | | | | | | | | | |
| Experimental | BrCl—ZnPc | FePc | 10:1 | 900° C. | N₂ | No | 529 | −3.1 | 26.7 | 0.79 | −3.4 | 49.6 | 0.94 |
| Example 25 | (F) | | | | | | | | | | | | |
| Experimental | BrCl—ZnPc | FePc | 10:1 | 900° C. | N₂ | No | 498 | −2.4 | 12.5 | 0.79 | −3.4 | 52.1 | 0.94 |
| Example 26 | (G) | | | | | | | | | | | | |
| Experimental | BrCl—ZnPc | FePc | 10:1 | 900° C. | N₂ | No | 476 | −3.5 | 11.6 | 0.79 | −3.9 | 40.6 | 0.95 |
| Example 27 | (H) | | | | | | | | | | | | |
| Experimental | ZnPc | — | — | 900° C. | N₂ | No | 14 | −0.1 | 46.9 | — | — | — | — |
| Example 28 | | | | | | | | | | | | | |
| Experimental | FePc | — | — | 900° C. | N₂ | No | 181 | −1.3 | 26.5 | 0.58 | — | — | — |
| Example 29 | | | | | | | | | | | | | |
| Experimental | ZnPc | FePc | 10:1 | 900° C. | N₂ | No | 17 | −0.6 | 15.6 | 0.68 | — | — | — |
| Example 30 | | | | | | | | | | | | | |
| Experimental | BrCl—ZnPc | FePc | 10:1 | 900° C. | 10% | No | 1390 | −5.5 | 5.3 | 0.89 | −5.6 | 9.9 | 0.99 |
| Example 31 | (A) | | | | NH₃ | | | | | | | | |
| Experimental | Experimental | — | — | — | — | Yes | 475 | −5.0 | 6.8 | 0.83 | −5.0 | 10.5 | 0.98 |
| Example 32 | Example 2 | | | | | | | | | | | | |
| Experimental | BrCl—ZnPc | FePc | 500:1 | 900° C. | N₂ | Yes | 502 | −3.8 | 8.1 | 0.77 | −4.3 | 19.3 | 0.87 |
| Example 33 | (B) | | | | | | | | | | | | |
| Reference | Platinum-supporting carbon | | | | | | | −5.5 | 7.7 | 0.89 | — | — | — |
| Example 1 | | | | | | | | | | | | | |

### (Evaluation of Carbon Dioxide Reduction Activity)

The carbon dioxide reduction activity of the carbon materials of Experimental Examples 1 to 33 was evaluated by the following method.

First, a catalyst electrode for measurement was produced in the same manner as in the evaluation of the oxygen reduction activity. Next, the carbon dioxide reduction activity of the catalyst electrode for measurement was evaluated by a three-electrode electrochemical cell method using an Ag/AgCl electrode (BAS Inc.; product number: 012167) as a reference electrode and a Pt coil electrode (BAS Inc.; product number: 012961) as a counter electrode. Specifically, first, the measurement system was stabilized by cycling in a range of from −1.8 to −0.7 V (vs. Ag/AgCl) at a scanning speed of 100 mV/s in a 0.5 M aqueous KHCO₃ (potassium hydrogen carbonate) solution saturated with argon (Ar), and then the LSV measurement was performed while rotating the catalyst electrode for measurement at 1600 rpm to obtain a voltammogram. Next, a voltammogram was obtained by performing LSV measurement while rotating the catalyst electrode for measurement at 1600 rpm in a 0.5 M aqueous KHCO₃ solution saturated with carbon dioxide (CO₂). The LSV measurement was performed by scanning in a range of from −0.8 to −0.1 V (vs. RHE) from a noble potential to a base potential at 5 mV/s. The voltammogram under argon saturation was subtracted from the voltammogram under carbon dioxide saturation to obtain a voltammogram of the carbon dioxide reduction reaction, and the obtained voltammogram was converted to the RHE reference based on the above equation (a) to obtain a current value at −0.7 V (vs. RHE). However, the value substituted for pH in the above equation (a) for converting the voltammogram to the RHE reference was 8.36. In the voltammogram of the carbon dioxide reduction reaction, the larger the current value in the negative direction, the higher the carbon dioxide reduction activity.

In this evaluation, the carbon material was determined to have carbon dioxide reduction activity (Evaluation A or B) when the current value at −0.7 V (vs. RHE) was −0.05 mA/cm² or less in the voltammogram of the carbon dioxide reduction reaction, and the carbon material was determined to have excellent carbon dioxide reduction activity (Evaluation A) when the current value at −0.7 V (vs. RHE) was less than −0.4 mA/cm² in the voltammogram of the carbon dioxide reduction reaction. The evaluation results are shown in Table 4. The evaluation result of the experimental example in which the carbon material was determined not to have carbon dioxide reduction activity was ranked as C.

### (Evaluation of Nitrogen Reduction Activity)

The nitrogen reduction activity of the carbon materials of Experimental Examples 1 to 33 was evaluated by the following method.

First, a catalyst electrode for measurement was produced in the same manner as in the evaluation of the oxygen reduction activity. Next, the nitrogen reduction activity of the catalyst electrode for measurement was evaluated by a three-electrode electrochemical cell method using an Ag/AgCl electrode (BAS Inc.; product number: 012167) as a reference electrode and a Pt coil electrode (BAS Inc.; product number: 012961) as a counter electrode. Specifically, first, the measurement system was stabilized by cycling in a range of from −1.7 to −0.5 V (vs. Ag/AgCl) at a scanning speed of 100 mV/s in a 0.1 M aqueous Na₂SO₄ (sodium sulfate) solution saturated with argon (Ar), and then the LSV measurement was performed while rotating the catalyst electrode for measurement at 1600 rpm to obtain a voltammogram. Next, a voltammogram was obtained by performing LSV measurement while rotating the catalyst electrode for measurement at 1600 rpm in a 0.1 M aqueous Na₂SO₄ solution saturated with nitrogen (N₂). The LSV measurement was performed by scanning in a range of from −0.8 to 0 V (vs. RHE) from a noble potential to a base potential at 5 mV/s. The voltammogram under argon saturation was subtracted from the voltammogram under nitrogen saturation to obtain a voltammogram of the nitrogen reduction reaction, and the obtained voltammogram was converted to the RHE reference based on the above equation (a) to obtain a current value at −0.8 V (vs. RHE). However, the value substituted for pH in the above equation (a) for converting the voltammogram to the RHE reference was 5.8. In the voltammogram of the nitrogen reduction reaction, the larger the current value in the negative direction, the higher the nitrogen reduction activity.

In this evaluation, the carbon material was determined to have nitrogen reduction activity (Evaluation A or B) when the current value at −0.8 V (vs. RHE) was −0.02 mA/cm² or less in the voltammogram of the nitrogen reduction reaction, and the carbon material was determined to have excellent nitrogen reduction activity (Evaluation A) when the current value at −0.8 V (vs. RHE) was less than −0.3 mA/cm² in the voltammogram of the nitrogen reduction reaction. The results are shown in Table 4. The evaluation result of the experimental example in which the carbon material was determined not to have nitrogen reduction activity was ranked as C.

TABLE 4

| | CO₂ reduction | N₂ reduction |
|---|---|---|
| | activity | activity |
| Experimental Example 1 | B | C |
| Experimental Example 2 | A | A |
| Experimental Example 3 | A | A |
| Experimental Example 4 | C | C |
| Experimental Example 5 | A | C |
| Experimental Example 6 | A | A |
| Experimental Example 7 | A | A |
| Experimental Example 8 | B | B |
| Experimental Example 9 | B | C |
| Experimental Example 10 | C | C |
| Experimental Example 11 | A | B |
| Experimental Example 12 | A | A |
| Experimental Example 13 | A | A |
| Experimental Example 14 | A | A |
| Experimental Example 15 | B | B |
| Experimental Example 16 | A | B |
| Experimental Example 17 | B | B |
| Experimental Example 18 | A | C |
| Experimental Example 19 | A | A |
| Experimental Example 20 | C | B |
| Experimental Example 21 | A | C |
| Experimental Example 22 | C | C |
| Experimental Example 23 | C | A |
| Experimental Example 24 | C | C |
| Experimental Example 25 | A | A |
| Experimental Example 26 | A | A |
| Experimental Example 27 | A | A |
| Experimental Example 28 | C | C |
| Experimental Example 29 | C | C |
| Experimental Example 30 | C | C |
| Experimental Example 31 | A | A |
| Experimental Example 32 | A | A |
| Experimental Example 33 | C | C |

1. A carbon material comprising a fired product of a mixture including a first compound and a second compound, wherein
the first compound is a phthalocyanine compound having bromine as a substituent, and
the second compound is a compound including at least one metal element selected from the group consisting of Fe, Co, Ni, Cu, Al, and Zn.

2. The carbon material according to claim 1, wherein the phthalocyanine compound includes Fe, Co, or Zn as a central metal.

3. The carbon material according to claim 1, wherein the phthalocyanine compound includes Zn as a central metal.

4. The carbon material according to claim 1, wherein the phthalocyanine compound has an average number of bromine atoms of 4 or more.

5. The carbon material according to claim 1, wherein
the phthalocyanine compound is in a powder form, and
a powder formed of the phthalocyanine compound has an average particle size of 300 nm or less.

6. The carbon material according to claim 1, wherein the second compound is a phthalocyanine compound or porphyrin compound having no bromine as a substituent.

7. The carbon material according to claim 1, wherein the second compound is a compound including Fe.

8. The carbon material according to claim 1, wherein a mass ratio of a content of the first compound to a content of the second compound in the mixture is from 0.1 to 2000.

9. A method for producing the carbon material described in claim 1, the method comprising:
firing a raw material including the first compound and the second compound.

10. A catalyst for use in a reduction reaction of oxygen, comprising the carbon material described in claim 1.

11. A dispersion liquid comprising the carbon material described in claim 1 and a dispersion medium for the carbon material.

12. The dispersion liquid according to claim 11, comprising a polymer electrolyte.

13. The dispersion liquid according to claim 11, the dispersion liquid being used for forming an electrode catalyst layer.

14. An electrode comprising an electrode catalyst layer including the carbon material described in claim 1.

15. The electrode according to claim 14, wherein the electrode catalyst layer includes a polymer electrolyte.

16. A battery comprising the electrode described in claim 14.

17. An electrolysis device comprising the electrode described in claim 14.
